(19) United States
(12) Patent Application Publication
(10) Pub. No.: US 2021/0053082 A1
(43) Pub. Date: Feb. 25, 2021

(54) CHEMICAL APPLICATOR

(71) Applicant: SILT CONTROL SOLUTIONS LIMITED, AUCKLAND (NZ)

(72) Inventor: THOMAS GADDUM, RED BEACH (NZ)

(21) Appl. No.: 16/543,936

(22) Filed: Aug. 19, 2019

(51) Int. Cl. B05B 12/12; C02F 1/52

(52) U.S. Cl. CPC B05B 12/12; C02F 1/5209

(57) ABSTRACT

A rain activated chemical applicator having: a means adapted to detect rainfall data and the means also being in communication with a controlling means; a controlling means; and a chemical dispensing means being in communication with the controlling means and wherein the chemical dispensing means comprises a manual priming pump to create a syphon, a valve, a flow meter and a discharge hose; the applicator is arranged such that when in use the applicator is connected to a storage means (e.g. a drum or tank) containing chemicals (e.g. flocculants and/or coagulation chemicals etc) and wherein when there is rainfall this is detected by the means adapted to detect rainfall date and the rainfall data is processed by the controlling means and the controlling means then determines the amount of chemicals that the chemical dispensing means should dispense into a body of water (e.g. a pond) and then the dispensing means dispenses these chemicals into the body of water. Sediment control is a significant environmental consideration when undertaking earthwork projects. The use of flocculants and/or coagulation chemicals is one way of controlling the sediment. Typically, these flocculants and coagulation chemicals are dispensed by chemical applicators. Known chemical applicators have high labour costs, are inaccurate and are prone to failure. The rain activated chemical applicator addresses this problem.

### FIELD OF INVENTION

The invention generally relates to a chemical applicator. More particularly, but not exclusively the invention relates to a rain activated chemical applicator.

### BACKGROUND

Sediment control is a significant environmental consideration when undertaking earthwork projects. The use of flocculants and/or coagulation chemicals is one way of controlling the sediment. Typically, these flocculants and coagulation chemicals are dispensed by chemical applicators. Known chemical applicators have high labour costs, are inaccurate and are prone to failure.

It is an object of a preferred form of the present invention to go at least some way towards addressing the above problem. While this is an object of a preferred embodiment, it should not be seen as a limitation on the scope of the invention as claimed. The object of the invention per se is simply to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in the United States of America or in any other country.

The term “comprising” and derivatives thereof, eg “comprises” if and when used herein in relation to a combination of features should not be taken as excluding the possibility that the combination may have further unspecified features. For example, a statement that an arrangement “comprises” certain parts does not mean that it cannot also, optionally, have additional parts.

### SUMMARY OF THE INVENTION

According to one aspect of the invention there is provided a rain activated chemical applicator having:
a means adapted to detect rainfall data and the means also being in communication with a controlling means;
a controlling means; and
a chemical dispensing means being in communication with the controlling means and wherein the chemical dispensing means comprises a manual priming pump to create a syphon, a valve, a flow meter and a discharge hose;

the applicator is arranged such that when in use the applicator is connected to a storage means (e.g. a drum or tank) containing chemicals (e.g. flocculants and/or coagulation chemicals etc) and wherein when there is rainfall this is detected by the means adapted to detect rainfall data and the rainfall data is processed by the controlling means and the controlling means then determines the amount of chemicals that the chemical dispensing means should dispense into a body of water (e.g. a pond) and then the dispensing means dispenses these chemicals into the body of water.

Preferably the means adapted to detect the rainfall data is a rain gauge.

Preferably the means adapted to detect the rainfall data is a solid state rain sensor.

Preferably the applicator has at least one solar panel adapted to convert energy from sunlight into electricity and wherein the electricity powers the controlling means and chemical dispensing means.

Preferably the applicator has at least one battery adapted to power the controlling means and chemical dispensing means.

Preferably the applicator has a communication means which enables it to send and receive data via the internet.

Preferably the communication means enables a user to monitor the amount of rainfall detected and the amount of chemicals dispensed by the applicator.

Preferably the chemicals dispensed are flocculants and/or coagulation chemicals.

Preferably the applicator is adapted to be screwed onto a drum or pod containing chemicals.

Preferably the applicator is adapted such that it can be carried by a user.

Preferably the applicator has at least one pH probe or sensor arranged to measure the pH of the body of water the chemicals are dispensed into.

Preferably applicator has at least one temperature sensor arranged to measure the temperature of the body of water the chemicals are dispensed into.

Preferably the applicator has at least one turbidity sensor arranged to detect the turbidity of the body of water.

Preferably the applicator has a turbidity, temperature and pH sensor within a housing along with a communication means wherein in use the sensors are placed within a body of water (e.g. a pond) and they provide feedback to analyse when chemicals are being more or less effective and send this information via the communication means to the controlling and dispensing means to close more effectively.

Preferably the controlling means comprises:
at least one computer processor; and
memory coupled with and readable by the at least one computer processor and comprising a series of instructions that, when executed by the at least one computer processor, cause the at least one computer processor to:

receive rainfall data; and

process the rainfall data; and

determine the amount of chemicals which should be dispensed.

Preferably the applicator has at least one turbidity sensor arranged to detect the turbidity of the body of water.

Preferably the applicator is arranged such that when in use turbidity data is processed by the controlling means and the controlling means then determines the amount of chemicals that the chemical dispensing means should dispense into a body of water (e.g. pond etc).

Preferably the body of water is a pond.

Preferably the applicator has warning means which creates a warning (e.g. audio such as a beeping sound, visual such as flashing LED lights or an alert via the internet to a user) when the chemicals in the storage means are empty or are getting low.

Preferably the applicator has as a mobile phone application associated with it which enables a user to send and receive data to and from the applicator via the communication means.

These and other features, objects and advantages of the present invention will be readily apparent to persons of ordinary skill in the art upon reading the entirety of this disclosure, which includes the accompanying drawings and claims.

### BRIEF DESCRIPTION OF THE DRAWINGS

Some preferred embodiments of the invention will now be described by way of example and with reference to the accompanying drawings and photos, of which:

FIG. 1 is a side view of a rain activated chemical applicator;

FIG. 2 is a perspective view of an alternative embodiment of a rain activated chemical applicator;

FIG. 3 is a perspective cut away view of the alternative embodiment of a rain activated chemical applicator;

FIG. 4 is a perspective view of the alternative embodiment of a rain activated chemical applicator screwed onto a chemical filed pod;

FIG. 5 is a side view of the alternative embodiment of a rain activated chemical applicator having a suction tube and outlet tube attached to it;

FIG. 6 is a perspective view of the alternative embodiment of a rain activated chemical applicator when screwed onto a chemical filled drum and having an outlet tube attached to it; and

FIG. 7 is an electrical schematic view of the alternative embodiment of a rain activated chemical applicator.

### DETAILED DESCRIPTION

The present invention generally relates to a rain activated chemical applicator for controlling sediment. The applicator is able to dispense chemicals in response to rain events.

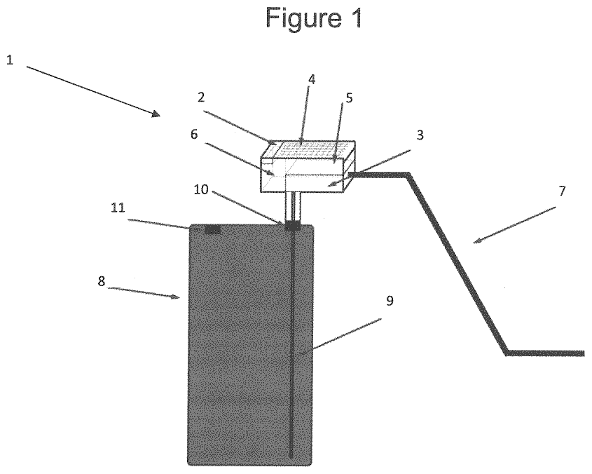

FIG. 1 shows a rain activated chemical applicator 1. As can be seen the applicator 1 has digital rain gauge 2 to measure rainfall rates and detect rain events. Those skilled in the art will appreciate that other means of detecting rain can be used (e.g. a weather station or rain sensor). The applicator 1 also has a pump 3 and a pump driver (not visible) to control the pump 3, a solar panel 4, a battery 5 and a computer processor 6. The solar panel 4 and battery 5 are able to power the computer processor 6, any sensors used, the pump 3 and pump driver. In the embodiment shown the gauge 2, pump 3, pump driver, solar panel 4, battery 5 and processor 6 are all contained within the same housing however in other embodiments they can differ.

With reference again to FIG. 1, one side of the applicator 1 connects to a discharge hose 7 which leads preferably to a sift retention pond or a decanting earth bunds flow entrance. The applicator 1 as shown also connects to a chemical filled (e.g. flocculants and coagulation chemicals) standard 200 litre PAC drum 8 and has a suction tube 9 which is inside the drum 8. The applicator 1 is screwed into the drum 8 with a mock screw cap 10. The drum 8 also has a second cap 11 for refilling etc. In some embodiments (not shown) the applicator 1 can attach to multiple drums or chemical tanks. Although not shown in a preferred embodiment the applicator 1 also has multiple turbidity sensors for measuring suspended solids at inflow, mid span and/or outflow of a pond or the like. The applicator 1 also preferably has a PH probe or sensor (not shown) to monitor the PH in settling ponds to ensure that it stays within acceptable limits. The applicator 1 also preferably has a temperature probe (not shown) as flocculants behave differently in varying temperatures. The applicator 1 also has a communication means (not shown) such that it can receive and send data via the internet. It also has cloud connectivity which allows for hosting for all data streamed offsite, dashboards, monitoring, secondary logic, site configuration and/or alert generation. In some embodiments the computer processor 6 in combination with the sensors is configured such that it can calculate the optimal dosage rates for the amount of rainfall in relation to the weather leading up to the current expected rainfall for example, if it has been dry for the last 30 days the applicator 1 will not close automatically as most of the initial rainfall will soak in and vice versa if it has been wet.

In use before installation firstly the required dosage rates (e.g. litres of chemical required per mm of rail fall) are uploaded to the computer processor 6 preferably via a mobile application. The rates are based on the contributing catchment area (e.g. size etc) and soil types etc. The applicator 1 is then installed. When used with a chemical drum 8 the applicator 1 is attached via a screw cap 10 with a suction tube 9 inside the drum. The screw cap 10 enables quick changes to full drums of chemicals. Those skilled in the art will appreciate that the applicator 1 can be used with different sized drums and pods (e.g. 200 litres, 1000 litres etc) or with flocculants/chemical holding tanks. A discharge hose 7 is arranged to discharge the chemicals into a channel upstream of the catchment area (e.g. a pond).

The digital rain gauge 2 which is in communication with the processor 6 collects data as the rain falls and the processor 6 processes this data and determines how much chemical (e.g. flocculants and/or coagulation chemicals) to release and initiates the pump 3 to release the required amount of chemicals as required by the closing rate programmed earlier. The applicator 1 is powered via solar 4 and battery 5 allowing for 24 hour functionality. The applicator 1 preferably has warning LED lights (not shown) when the chemical is running low or is empty. The applicator can also have an audio warning such as a beeping sound or send an alert via the internet to a user. The applicator 1 also has an override manual switch to enable for batch dosing if this is required. In some embodiments instead of rainfall, the amount of chemical released can be based on turbidity using turbidity sensors (e.g. measuring suspended solids at inflow, mid span and/or outflow).

In some embodiments the applicator 1 has turbidity, temperature and pH sensors in the pond which create feedback and smart machine decision (AI) to dose in relation to the environment. The sensors can all be in one unit inside a casing and having a wireless communication means or can be separated and each having wireless communication means so that they can send and receive information regarding the turbidity, temperature and pH. Those skilled in the art will appreciate that flocculants behave differently depending on temperature, pH and soil type. Continuous feedback from the turbidity sensor, pH sensor/probe and temp sensor/probe will allow the system to analyse when flocculent is being more or less effective and thus dosing accordingly more or less and overall more effectively. Furthermore, in use the more applicators and sensors that are installed the more data which can be retrieved and this will enable more accurate dosing.

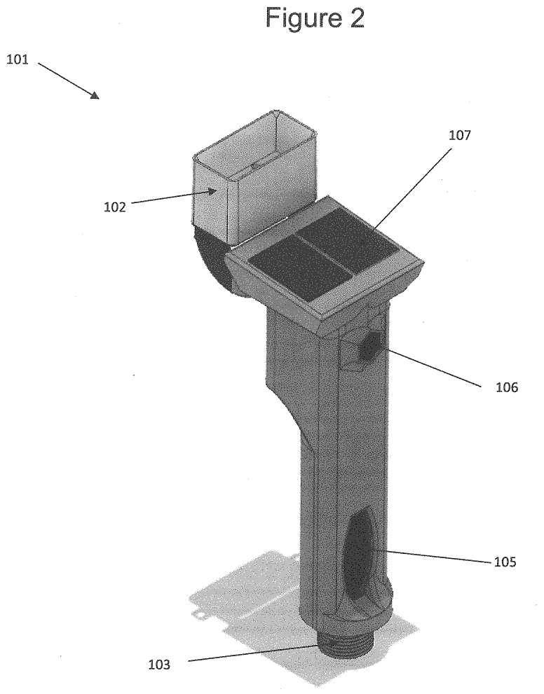

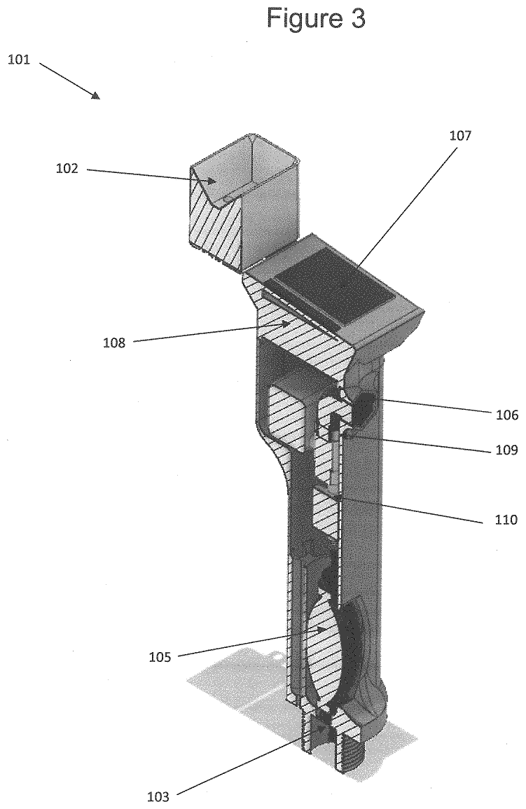

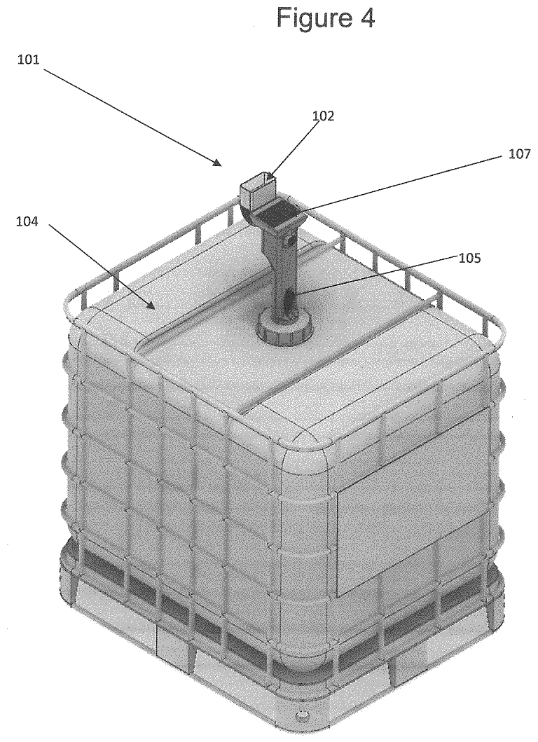

FIGS. 2 and 3 show an alternative embodiment of a rain activated chemical applicator 101. As can be seen the applicator 101 has rain gauge (e.g. a tipping bucket or solid state rain sensor) 102 to measure rainfall rates and detect rain events. The applicator 101 has an inlet 103 which is adapted such that the chemical applicator 101 can screw onto a chemical filed drum or pod (e.g. a 1000 litre pod etc). FIG. 4 shows the applicator 101 when screwed onto a chemical filed pod 104. Located above the inlet 103 is a manual priming pump 105. As can be seen the applicator 101 also has an outlet 106 which adapted to receive a hose (not shown). On top of the applicator 101 is a solar panel or panels 107 and a battery (not visible) and these power the computer processor, electronics, circuit board, antenna, and communication software and hardware 108 which are located at the top of the applicator 101 below the solar panel 107. The applicator 101 also has a valve 109 (e.g. a motorised ball valve), a means to open the valve (not shown) and a flow meter 110 and a switch most preferably a magnetic switch (not shown) to turn the unit on and off and a speaker (not shown).

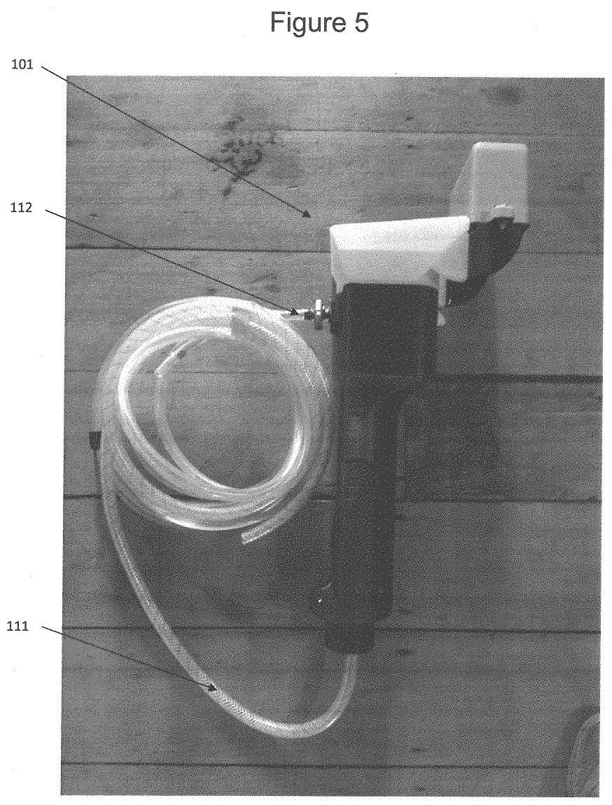

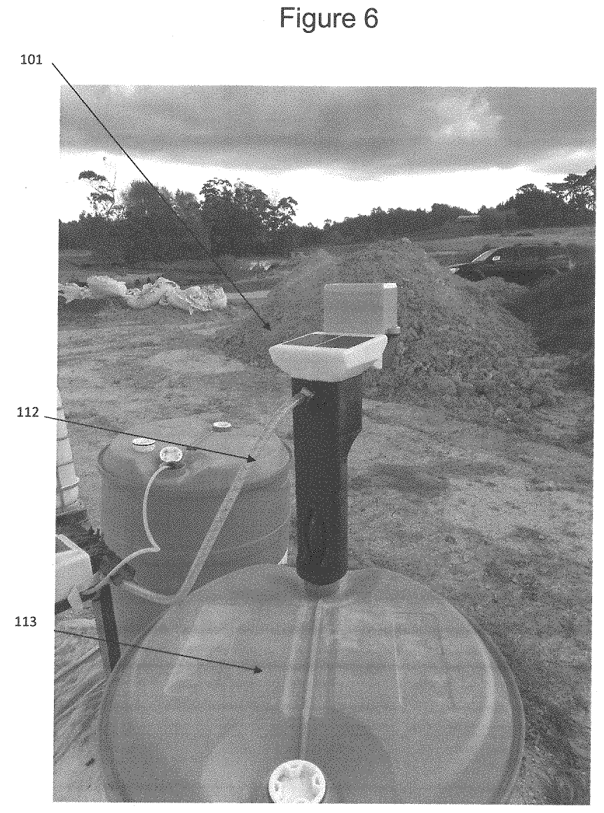

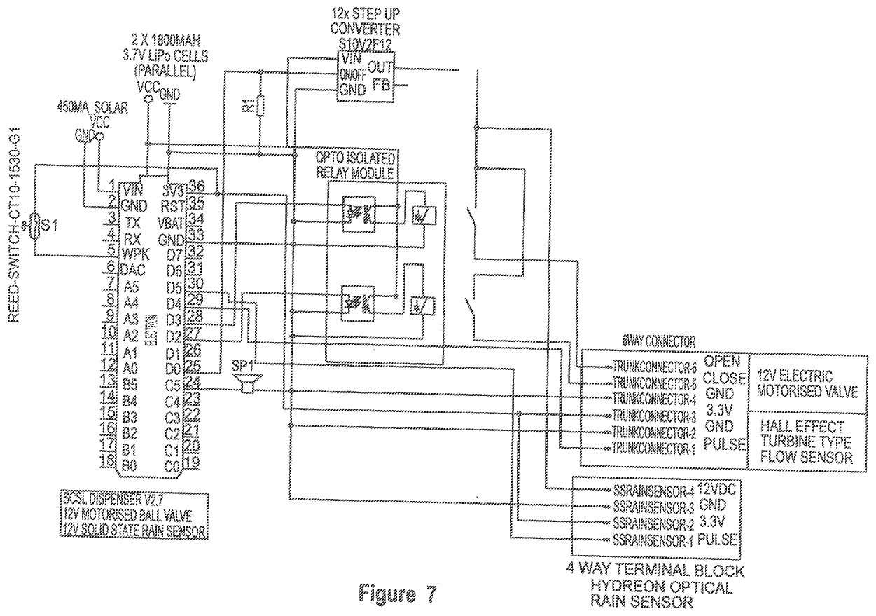

FIG. 5 shows the chemical applicator 101 with a suction tube 111 attached to the manual priming pump and a discharge tube/pipe 112 attached to the outlet. FIG. 6 illustrates the chemical applicator 101 attached to a chemical filed drum 113 and FIG. 7 is an electrical schematic of the applicator 101.

In use before installation firstly the required dosage rates (e.g. litres of chemical required per mm of rail fall) are uploaded to the computer processor 6 preferably via a mobile application. The rates are based on the contributing catchment area (e.g. size etc) and soil types etc. The applicator 101 is then screwed onto a chemical pod or drum 104, 113 and the suction tube 111 goes inside the pod or drum 104, 113. Those skilled in the art will appreciate that the applicator 101 can be used with different sized drums and pods (e.g. 200 litres, 1000 litres etc) or with flocculant/chemical holding tanks. A discharge hose 112 is arranged to discharge the chemicals into a channel upstream of the catchment area (e.g. a pond).

The applicator 101 is then turned on to a “commissioning mode” via the magnetic switch and will preferably make two audible beeps via the speaker. Once the applicator 101 is in “commissioning mode” the applicator 101 will connect to the internet and cloud via the wireless communication means. Once connection has been established the applicator 101 will open the valve 109. Once the valve 109 is open the manual pump 105 is engaged by a user and this results in chemicals being sucked out of the drum 113 or pod through the applicator 101 and out the discharge pipe/tube 112 creating a siphon. Once a siphon is established and chemicals are flowing due to this siphon the applicator 101 will preferably dose the chemicals at an exact mount e.g. one litre. The dose will be measured precisely via the flow meter 110. After the exact chemical is dosed the valve 109 will close. The applicator 101 will be then switched to “live mode” using the magnetic switch and this “live mode” is established after a user hears three beeps. To turn the applicator 101 off one beep is required via the magnetic switch. Once in “live mode”, when the rain gauge 102 recognises precipitation it will dose according to the rate and catchment areas set via the online portal. It does this by opening the valve 109, this allows the siphon to work and doses the prescribed amount accurately by utilising the flow meter 110. It stops by closing the valve 109 and continues to hold the siphon until another rainfall event. Warning alerts are given when a siphon is lost or chemical runs out. By utilising a manual priming pump 105 to create a syphon, a valve 109 and a flow meter 101 the need for a powered pump is removed. A powered pump adds a huge amount of power draw and thus a larger battery and solar panels are required when not utilising a manual priming pump 105. By shifting to a siphon system the applicator 101 has maintained height for dosing into ponds compared to just having an outlet on the bottom of a storage tank and a valve operating

The applicator 1, 101 has a number of advantages and benefits over known applicators. For example, there are huge amounts of labour involved in current systems, they are also expensive to setup, prone to failure either due to weather conditions or human labour involved not being completed e.g. failure to refill the chemical or failure to manually prime to the correct level. Also known dosing devices can lead to inaccurate dosing of ponds and it is difficult to change the dosing rate on devices. Overdosing of ponds can result in ecological issues in waterways and underdoing can result in sediment expulsion. Furthermore, known devices lack a warning system other than inspection by a trained user. The applicator 1, 101 also allows for sites to be monitored from a distance and provides regulatory bodies with dosing data. The applicator 1, 101 can also be used in other dosing practices or for irrigation etc. The applicator 101 is also much smaller than prior art applicators due to the minimal energy required to operate it than if a powered pump was required and this ensures that the applicator 101 is easily portable into remote areas and have minimal setup. By removing the power consumption constraint the device can now dose far larger catchments as all it has to do is open the valve 109 an dose accordingly with respect to the flow meter 110 so no power consumption is used whilst the valve 109 is open but still continues to dose. The system is far simpler without a pump as well which minimises room for production error, break downs and maintenance. The flow meter 110 measures precise quantities of flocculants rather than valve open x time dosing logic. The flow meter 110 and valve 109 also enables lengthier dosing periods. This ensures greater mixing rather than just dumping chemicals all at once. Known dosing devices can lead to inaccurate dosing of ponds and it is difficult to change the dosing rate on known devices. Overdosing of ponds can result in ecological issues in waterways and underdoing can result in sediment expulsion

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example, the particular elements of the applicator (e.g. the rain gauge, sensors, pump, solar panels, battery, processor, mobile application, discharge hose etc) may vary dependent on the particular application for which it is used without variation in the spirit and scope of the present invention. In addition, although the preferred embodiments described herein are directed to a chemical applicator it will be appreciated by those skilled in the art that variations and modifications can be made within the scope of the appended claims.

1. A rain activated chemical applicator having:
a means adapted to detect rainfall data and the means also being in communication with a controlling means;
a controlling means; and
a chemical dispensing means being in communication with the controlling means and wherein the chemical dispensing means comprises a manual priming pump to create a syphon, a valve, a flow meter and a discharge hose;
the applicator is arranged such that when in use the applicator is connected to a storage means containing chemicals and wherein when there is rainfall this is detected by the means adapted to detect rainfall data and the rainfall data from this is processed by the controlling means and the controlling means then determines the amount of chemicals that the chemical dispensing means should dispense into a body of water and then the dispensing means dispenses these chemicals into the body of water.

2. A rain activated chemical applicator according to claim 1, wherein the means adapted to detect the rainfall data is a rain gauge.

3. A rain activated chemical applicator according to claim 1, wherein the means adapted to detect the rainfall data is a solid state rain sensor.

4. A rain activated chemical applicator according to claim 1, having at least one solar panel adapted to convert energy from sunlight into electricity and wherein the electricity powers the controlling means.

5. A rain activated chemical applicator according to claim 1, wherein the applicator has at least one battery adapted to power the controlling means.

6. A rain activated chemical applicator according to claim 1, having a communication means which enables it to send and receive data via the internet.

7. A rain activated chemical applicator according to claim 1, having a communication means which enables it to send and receive data via the internet, wherein the communication means enables a user to monitor the amount of rainfall detected and the amount of chemicals dispensed by the applicator.

8. A rain activated chemical applicator according to claim 1, wherein the chemicals dispensed are flocculants and/or coagulation chemicals.

9. A rain activated chemical applicator according to claim 1, wherein the base of the applicator is adapted to be screwed onto a storage means containing chemicals.

10. A rain activated chemical applicator according to claim 1, wherein the base of the applicator is adapted to be screwed onto a storage means containing chemicals and wherein the storage means is a drum or a pod.

11. A rain activated chemical applicator according to claim 1, having a magnetic switch which turns the applicator on and off.

12. A rain activated chemical applicator according to claim 1, having a warning means which creates a warning to a user when the chemicals in the storage means are empty or are getting low.

13. A rain activated chemical applicator according to claim 1, wherein the applicator is adapted such that it can be carried by a user.

14. A rain activated chemical applicator according to claim 1, wherein the controlling means comprises:
at least one computer processor; and
memory coupled with and readable by the at least one computer processor and comprising a series of instructions that, when executed by the at least one computer processor, cause the at least one computer processor to:
receive rainfall data; and
process the rainfall data; and
determine the amount of chemicals which should be dispensed.

15. A rain activated chemical applicator according to claim 1, wherein the applicator has a communication means and has a mobile phone application associated with the communication means which enables a user to send and receive data to and from the applicator via the communication means.

16. A rain activated chemical applicator according to claim 1, wherein the body of water is a pond.
